(19) United States
(12) Patent Application Publication
(10) Pub. No.: US 2018/0354578 A1
(43) Pub. Date: Dec. 13, 2018

(54) BICYCLE HANDLEBAR ASSEMBLY

(71) Applicant: TH INDUSTRIES CO., LTD., TAICHUNG (TW)

(72) Inventor: HUNG-MAO GU, TAICHUNG (TW)

(21) Appl. No.: 15/618,146

(22) Filed: Jun. 9, 2017

(51) Int. Cl. B62K 21/22; B62K 21/12

(52) U.S. Cl. CPC B62K 21/22; B62K 21/12

(57) ABSTRACT

A bicycle handlebar assembly includes a stem, two handles and a plurality of fastening members. The stem includes a left extension portion and a right extension portion, with both of the left extension portion and the right extension portion having at least one mounting hole. Each of the handles has a grip portion at one end and a connecting portion at the other end, wherein the connecting portion includes at least two connecting structures. The connecting portions of the handles are detachably mounted onto the left extension portion and the right extension portion, and the fastening members extend through the mounting holes of the stem and the connecting portion so as to secure the stem and the handles together in a non-rotatable manner.

### FIELD OF THE INVENTION

The present disclosure relates to a handle structure, and more particularly to a bicycle handlebar assembly.

### BACKGROUND OF THE INVENTION

National healthy activities have been deeply rooted in mind and spread to the whole society. Bicycle is one of the popular sports. Riding bicycle is not only a healthy activity but also a means to make a grand tour.

To satisfy various requirements, such as traffic, short trip, racing, long-term trip, ironman triathlon, the handles of bicycles have various types. In addition to general flat bars and drop handles, aero handlebars, extension handle bar or other handles of various types and functions are also popular in recent years so that bicycle riders may enjoy the riding as possible as they can with various handles.

For aero handlebars which are frequently seen in riding activities, the aero handlebar is often combined with an extension handle bar for high energy-consumption sport such as ironman triathlon. Since the combination of the aero handlebar and the extension handle bar makes the drop to be a constant and not adjustable. The term “drop” means the height difference between the grip portion of the handle bar and a stem.

In addition, the width of a conventional handle is not adjustable, either. A handle is not necessary to fit all riders. The rider not suitable for the handle due to body size needs to replace the handle with a new one fitting his/her body size.

### SUMMARY OF THE INVENTION

An object of the present disclosure is to provide a bicycle handlebar assembly, wherein the drop of the grip portion is adjustable and a distance between two grip portions is also adjustable. The bicycle handlebar assembly of the present disclosure fits riders of different body sizes and riding habits.

An embodiment of the bicycle handlebar assembly includes a stem, two handles and a plurality of fastening members. The stem includes a left extension portion having at least one mounting hole and a right extension portion having at least one mounting hole. Each of the handles has a grip portion at one end and a connecting portion at the other end, wherein the connecting portion includes at least two connecting structures. The connecting portions of the handles are detachably mounted onto the left extension portion and the right extension portion, and the fastening members extend through the mounting holes of the stem and the connecting portion so as to secure the stem and the handles together in a non-rotatable manner.

In another embodiment, the bicycle handlebar assembly comprise at least one joining member, the joining member further includes joining structures on two opposite sides for selectively joining the connecting holes of the left extension portion and the right extension portion or the connecting structures of the handle. The at least one joining member, the stem and the handle are exchangeably stacked, and the fastening members extend through the connecting structures of the at least one joining member, the at least one mounting hole of the stem and the connecting structures of the handle to secure the at least one joining member, the stem and the handle together.

In another embodiment, the bicycle handlebar assembly further includes a connecting seat for an extension handle, wherein the connecting seat includes a linking structure and is mounted to the stem or disposed above or under the handles, and the fastening members extend through the linking structure of the extension handle base, the mounting hole of the stem and the connecting structures of the handle to secure the connecting seat, the stem and the handle together.

In another embodiment, the connecting seat further includes a clamping portion for the extension handle and a mounting portion for a pad, and the mounting portion includes a plurality of positioning holes configured to position the pad.

In another embodiment, the linking structure of the extension handle includes at least two screw holes.

Therefore, a bicycle handlebar assembly of the present disclosure is able to adjust the drop of the grip portion through several connecting structures and spacers and is also able to adjust the distance between two grip portions through several connecting structures having different distance from the grip portion. The bicycle handlebar assembly of the present disclosure can be modified to fit riders of different body sizes and riding habits without having to prepare several bicycle handles of different specifications.

### BRIEF DESCRIPTION OF THE DRAWINGS

The present disclosure will become more readily apparent to those ordinarily skilled in the art after reviewing the following detailed description and accompanying drawings, in which:

FIG. 1 is a schematic diagram of a handle of a bicycle handlebar assembly of the present disclosure;

FIG. 2A is a perspective view of an embodiment of a bicycle handlebar assembly of the present disclosure;

FIG. 2B is an exploded view of FIG. 2A;

FIG. 2C is a front view of FIG. 2A;

FIG. 3 is a front view of another embodiment of a bicycle handlebar assembly of the present disclosure;

FIG. 4 is a front view of another embodiment of a bicycle handlebar assembly of the present disclosure;

FIG. 5 is a front view of another embodiment of a bicycle handlebar assembly of the present disclosure; and

FIG. 6 is a front view of another embodiment of a bicycle handlebar assembly of the present disclosure.

### DETAILED DESCRIPTION OF PREFERRED EMBODIMENTS

The present disclosure will now be described more specifically with reference to the following embodiments. It is to be noted that the following descriptions of preferred embodiments of present disclosure are presented herein for purpose of illustration and description only. It is not intended to be exhaustive or to be limited to the precise form disclosed.

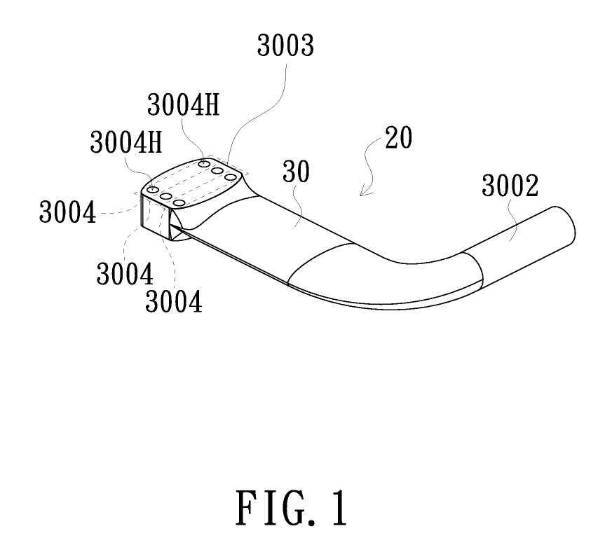

The present disclosure is related to a bicycle handlebar assembly. Referring to FIG. 1, FIG. 1 is schematic view of a handle 20 of the present disclosure. The handle 20 is used in a bicycle handlebar assembly of a bicycle. In fact, the handle 20 is a bar 30.

The bar 30 includes a grip portion 3002 at one end. A rider may hold the bar 30 when he/she is riding the bicycle. The bar 30 further includes a connecting portion 3003 at the other end. The connecting portion 3003 includes at least two connecting structures 3004, which has different distances from the grip portion 3002. In this embodiment, the connecting portion 3003 includes three connecting structures 3004. Each of the connecting structures 3004 includes at least one connecting holes 3004H and a surface which can smoothly abut to other fastening members. As shown in FIG. 1, the bar 30 includes three connecting structures 3004 at the other end, and each of the connecting structures 3004 has two connecting holes 3004H.

The handle 20 can be a flat bar, a drop handle or an aero handlebar. In this embodiment, the handle 20 is an aero handlebar. As shown in FIG. 1, the handle 20 is L-shaped, and the grip portion 3002 of the handle 20 extends from the handle 20 toward a front side of the bicycle.

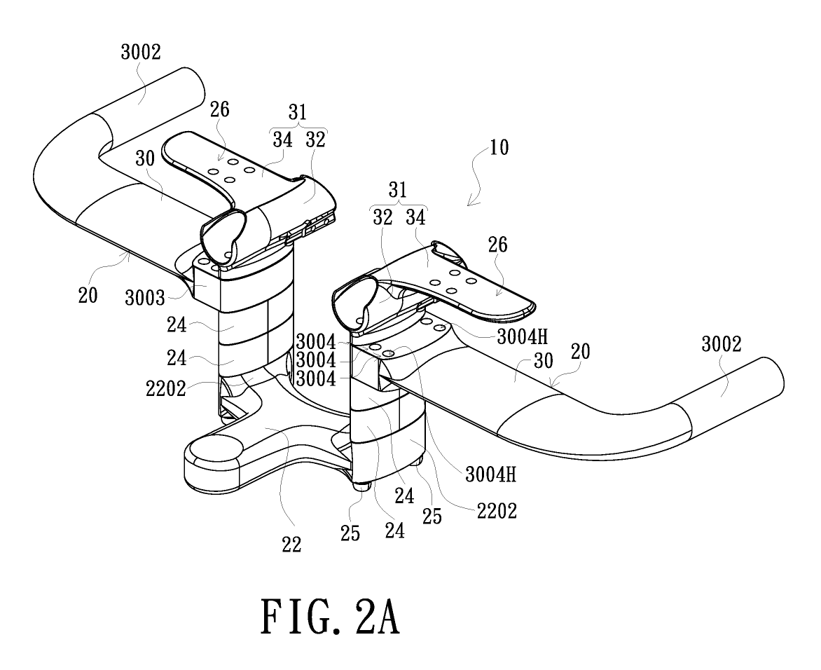

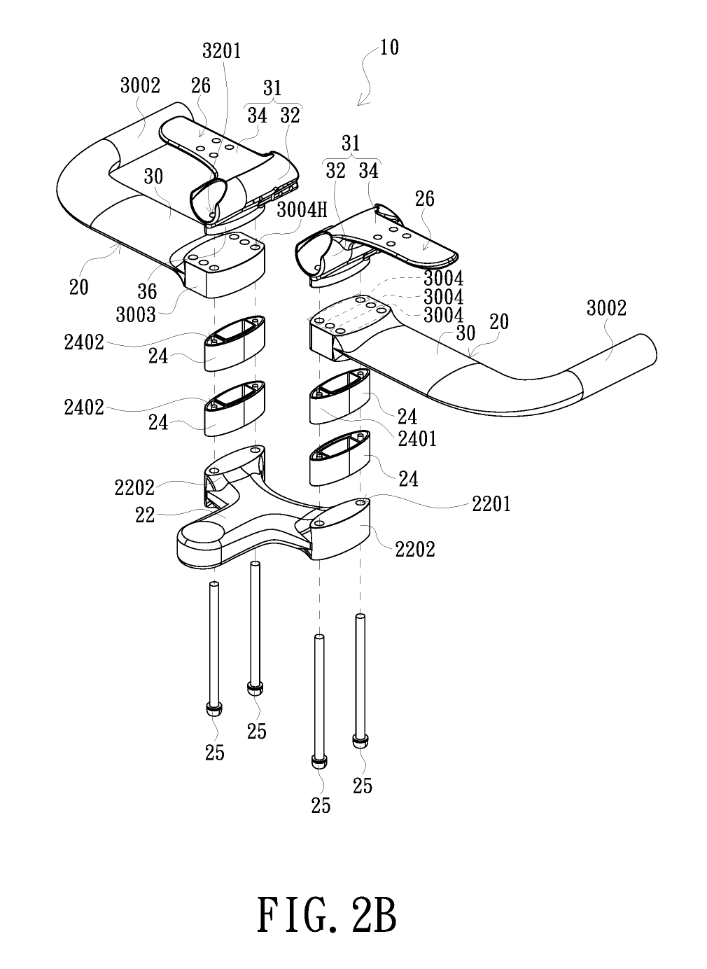

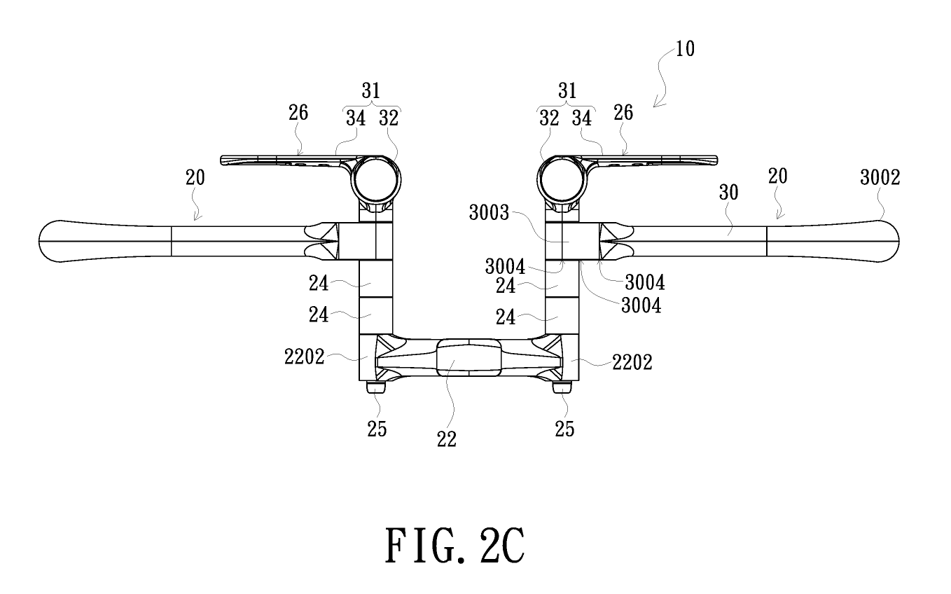

Referring to FIGS. 2A to 2C, FIG. 2A is a perspective view of an embodiment of a bicycle handlebar assembly 10 of the present disclosure, FIG. 2B is an exploded view of FIG. 2A, and FIG. 2C is a front view of FIG. 2A. The bicycle handlebar assembly 10 of the present disclosure includes the handles 20, a stem 22, a plurality of fastening member 25, at least one joining member 24 and two extension handle bases 26. In this embodiment, the bicycle handlebar assembly 10 of the present disclosure includes two joining members 24.

The handle 20 of FIGS. 2A to 2C is a bar 30. As shown in FIG. 1, the bar 30 includes the grip portion 3002 at one end and three connecting structures 3004 at the other end. Each of the connecting structures 3004 has different distance to the grip portion 3002 and includes two connecting holes 3004H.

The stem 22 includes two mounting bases 2202 which are a left extension portion and a right extension portion. Each of the left extension portion and the right extension portion has at least one mounting holes 2201. In this embodiment, each of the left extension portion and the right extension portion has two mounting holes 2201. The connecting portion 3003 is detachably disposed above or under the left extension portion or the right extension portion, and the fastening members 25 extend through the holes of the stem 22 and the connecting structures 3004 of the handle 20 so as to secure the stem 22 and the handles 20 together in a non-rotatable manner.

In addition, the joining member 24 includes two joining structures 2401 for selectively joining the connecting holes 3004H of the left extension portion; the connecting holes 3004H of the right extension portion or the connecting structure 3004 of the handle 20. Each of the joining structures 2401 further include at least one through holes 2402. The joining member 24, the stem 22 and the handles 20 are exchangeably stacked, and the fastening members 25 extend through the through hole 2402 of the joining member 24, the mounting hole 2201 of the stem 22 and the connecting structures of the handle 20 to secure the joining member 24, the stem 22 and the handle 20 together.

As shown in FIGS. 2A to 2C, there are four joining members 24 stacked on the two mounting bases 2202. Each of mounting bases 2202 has two joining members 24 stacked thereon. Each of the joining members 24 also has two through holes 2402. The handle 20 is disposed on the stacked joining members 24, and the extension handle base 26 is disposed on the handle 20.

The extension handle base 26 includes a connecting seat 31, an extension handle (not shown), and a pad (not shown). The connecting seat 31 also includes a linking structure 36 and at least one linking holes 3201. The connecting seat 31 can be disposed above or under the stem 22 or the handles 20. The fastening members 25 extend through the linking hole 3201 of the extension handle base 26, the mounting hole 2201 of the mounting base 2202 of the stem 22 and the connecting hole 3004H of the connecting structure 3004 of the handle 20 to secure the connecting seat 31, the stem 22 and the handle 20 together in a non-rotatable manner.

The at least one linking hole 3201 of linking structure 36 of the extension handle base 26 is opened downwardly. In this embodiment, the linking structure 36 includes two linking holes 3201. The both linking holes 3201 of the linking structure 36 of the extension handle base 26, two of the connecting holes 3004H of the connecting structure 3004 of the handle 20, the both through holes 2402 of the two joining member 24 and two of the mounting holes 2201 of mounting base 2202 of the stem 22 are arranged from top to bottom and sequentially aligned. The fastening members 25, such as bolts, extend through the sequentially aligned holes from bottom to top and secure the stem 22, the two joining member 24, the handle 20 and the extension handle base 26 together to form a stable and adjustable bicycle handlebar assembly 10. In the present embodiment the linking structure has two linking holes 3201, but the present disclosure is not limited thereto. In another embodiment, the linking holes 3201 of the linking structure can also be replaced by screw holes.

The connecting seat 31 includes a clamping portion 32 and a mounting portion 34. The clamping portion 32 clamps the extension handle (not shown) which allows the rider to hold the handle 20 with another riding posture. The mounting portion 34 includes a plurality of positioning holes configured to position the pad. The rider can rest his/her arm easily on the pad when he/she holds the extension handle.

The handle 20 is connected to the mounting base 2202 of the stem 22, the joining member 24 or the extension handle base 26 through the connecting structures 3004. In addition to the structure of the bicycle handlebar assembly of FIG.1, several embodiments of the bicycle handlebar assembly of the present disclosure are constructed in a similar way, and they are described as follows.

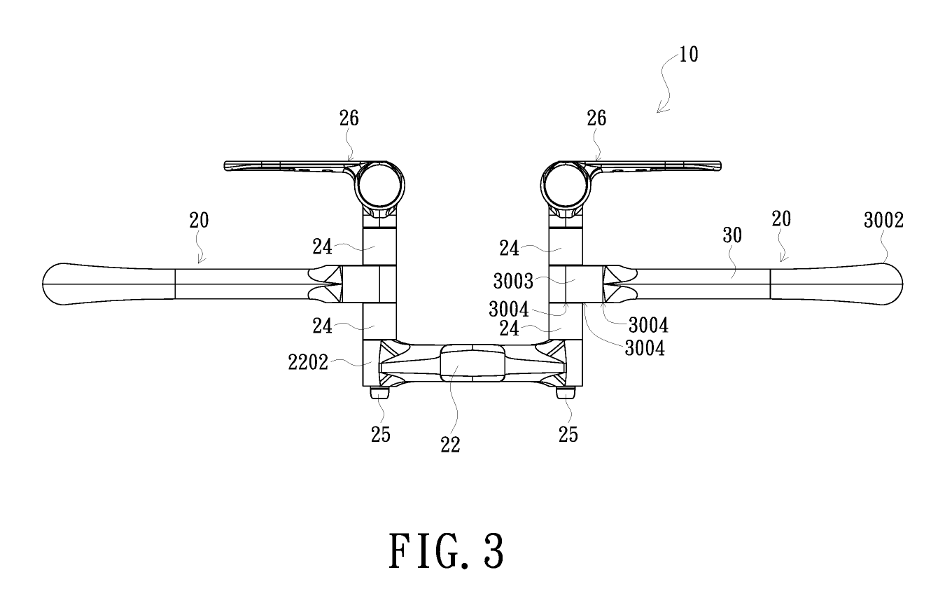

Referring to FIG. 3, FIG. 3 is a front view of another embodiment of a bicycle handlebar assembly 10 of the present disclosure. The bicycle handlebar assembly 10 of this embodiment has the same components as the bicycle handlebar assembly 10 of the previous embodiment, but the arrangement of the components is different. In this embodiment, the stem 22 is located in the bottommost position, and the handle 20 is connected to the both joining members 24 and positioned between them. Two linking holes 3201 of the extension handle base 26, two through holes 2402 of the joining member 24 at a higher position, two connecting holes 3004H of the connecting structure 3004 of the bar handle 20, two through holes 2402 of the joining member 24 at a lower position and two mounting holes 2201 of the mounting base 2202 of the stem 22 are arranged from top to bottom and sequentially aligned. The fastening members 25 extend through the sequentially aligned holes from bottom to top and secure the extension handle base 26, the joining member 24 at a higher position, the bar 30, the joining member 24 at a lower position and the stem 22 together to form another bicycle handlebar assembly 10.

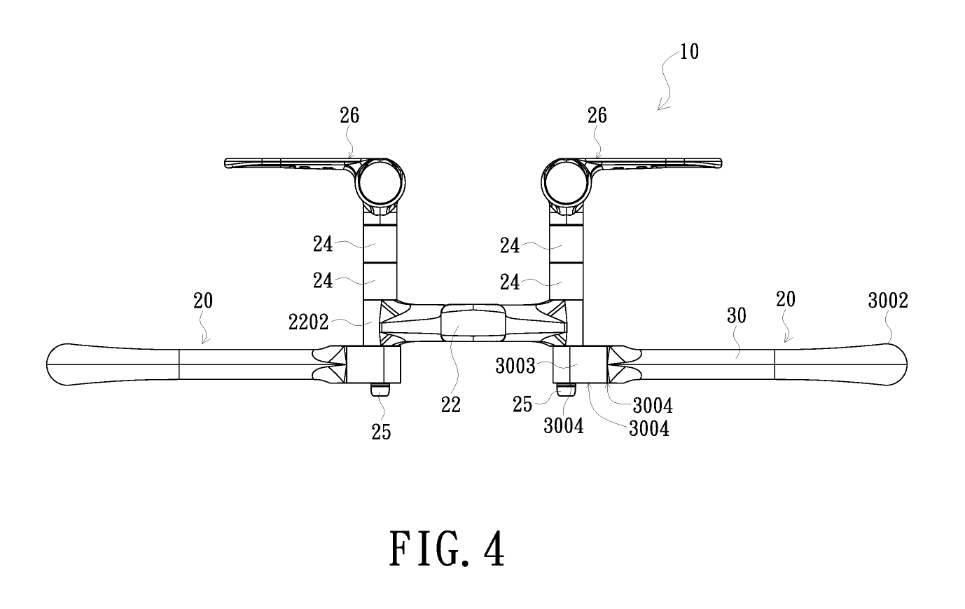

Referring to FIG. 4, FIG. 4 is a front view of another embodiment of a bicycle handlebar assembly 10 of the present disclosure. The bicycle handlebar assembly 10 of this embodiment has the same components as the bicycle handlebar assembly 10 of the previous embodiment has, but the arrangement of the components is different. In this embodiment, the bar 30 is located in the bottommost position. Two linking holes 3201 of the extension handle base 26, the through holes 2402 of the two joining member 24, two mounting holes 2201 of the mounting base 2202 of the stem 22 and two connecting holes 3004H of the connecting structure 3004 of the bar 30 are arranged from top to bottom sequentially and aligned. The fastening members 25 extend through the sequentially aligned holes from bottom to top and secure the extension handle base 26, the joining members 24, the stem 22 and the bar 30 together to form another bicycle handlebar assembly 10.

Therefore, the bicycle handlebar assemblies 10 of aforementioned embodiments have different drop values due to different arrangements of their components. If there are more joining members 24 or other joining members of different types being added, more bicycle handlebar assembly 10 of different types can be created for the riders. Thus the riders can modify the handle structure of the present disclosure to several handles of different types for corresponding to various riding conditions only by re-arrangement of components or supplementation of new components without having to prepare several bicycle handles of different specifications.

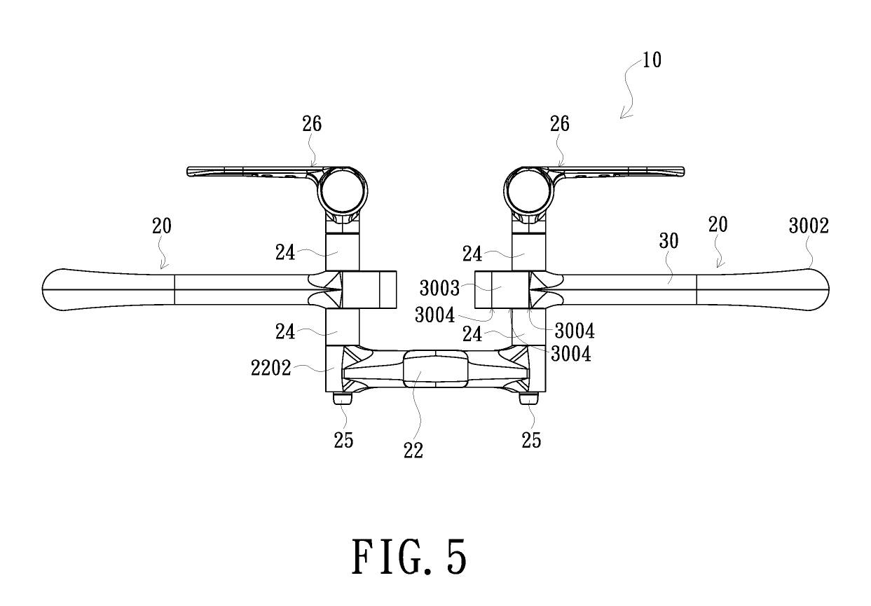

Referring to FIG. 5, FIG. 5 is a front view of another embodiment of a bicycle handlebar assembly 10 of the present disclosure. In this embodiment, the bicycle handlebar assembly 10 has the same components as the bicycle handlebar assemblies 10 of the previous embodiments, and also has an arrangement similar to bicycle handlebar assembly 10 of FIG. 3. The connecting structure 3004 closest to the grip portion 3002 is used to connect the joining members 24 in this embodiment. Two linking holes 3201 of the extension handle base 26, two through holes 2402 of the joining member 24 at a higher position, two connecting holes 3004H of the connecting structure 3004 of the bar 30, two through holes 2402 of the joining member 24 at a lower position and two mounting holes 2201 of the mounting base 2202 of the stem 22 are arranged from top to bottom sequentially and aligned. The fastening members 25 extend through the sequentially aligned holes from bottom to top and secure the extension handle base 26, the joining member 24 at a higher position, the bar 30, the joining member 24 at a lower position and the stem 22 together to form another bicycle handlebar assembly 10 which has a width between two grip portions 3002 different from that of the bicycle handlebar assembly 10 of FIG. 3.

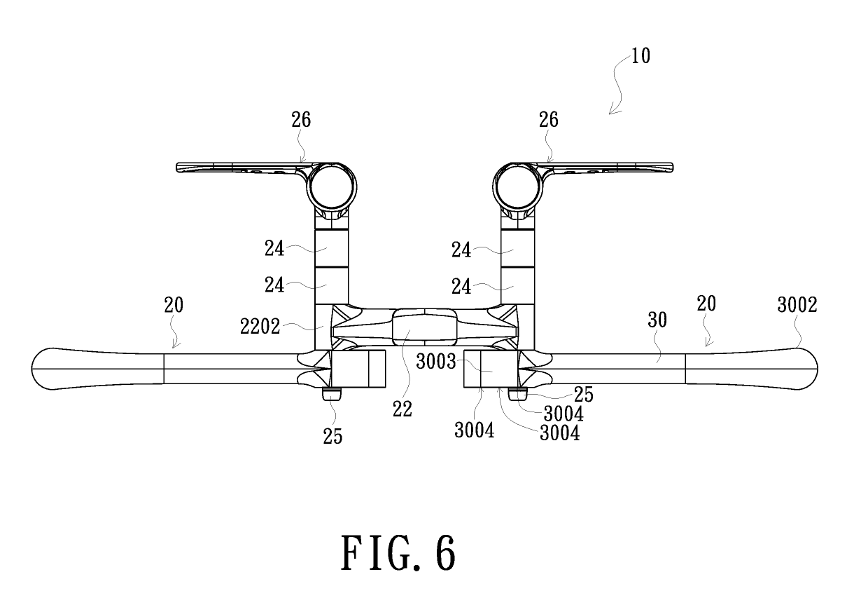

Referring to FIG. 6, FIG. 6 is a front view of another embodiment of a bicycle handlebar assembly 10 of the present disclosure. In this embodiment, the bicycle handlebar assembly 10 has the same components as the bicycle handlebar assemblies 10 of the previous embodiments have, and also has an arrangement similar to bicycle handlebar assembly 10 of FIG. 4. The connecting structure 3004 closest to the grip portion 3002 is used to connect the stem 22 in this embodiment. Two linking holes 3201 of the extension handle base 26, two through holes 2402 of the two joining member 24, two mounting holes 2201 of the mounting base 2202 of the stem 22 and two connecting holes 3004H of the connecting structure 3004 of the bar 30 are arranged from top to bottom and sequentially aligned. The fastening members 25 extend through the sequentially aligned through holes from bottom to top and secure the extension handle base 26, the joining members 24, the stem 22 and the bar 30 together to form another bicycle handlebar assembly 10which has a width between two grip portions 3002 different from that of the bicycle handlebar assembly 10 of FIG. 4.

As the bar 30 has three connecting structures 3004 as shown in FIG. 1, the bicycle handlebar assembly 10 can be modified to have three different widths. Furthermore, as long as the bar 30 has connecting structures 3004 with different distance to the grip portion 3002, the bicycle handlebar assembly 10 can be modified to have different width corresponding to the different distance to the grip portion 3002.

Therefore, a bicycle handlebar assembly 10 of the present disclosure is able to adjust the drop of the grip portion 3002 through several connecting structures 3004 and spacers and is also able to adjust the distance between two grip portions 3002 through several connecting structures 3004 having different distance from the grip portion 3002. The bicycle handlebar assembly 10 of the present disclosure can be modified to fit riders of different body sizes and riding habits without having to prepare several bicycle handles of different specifications.

While the present disclosure has been described in terms of what is presently considered to be the most practical and preferred embodiments, it is to be understood that the present disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A bicycle handlebar assembly, comprising:
a stem, comprising a left extension portion and a right extension portion, both of the left extension portion and the right extension portion having at least one mounting hole;
two handles, each of the handles having a grip portion at one end and a connecting portion at the other end, wherein the connecting portion comprises at least two connecting structures; and
a plurality of fastening members, wherein the connecting portions of the handles are detachably mounted onto the left extension portion and the right extension portion, and the fastening members extend through the mounting holes of the stem and the two connecting portions respectively so as to secure the stem and the two handles together in a non-rotatable manner.

2. The bicycle handlebar assembly according to claim 1, further comprising at least one joining member, and the joining member further comprising joining structures for selectively joining the mounting holes of the left extension portion and the right extension portion or the connecting structures of one of the handles, wherein the at least one joining member, the stem and the one of the handles are exchangeably stacked, and the fastening members extend through the joining structures of the at least one joining member, the at least one mounting hole of the stem and a connecting hole of the connecting structures of the one of the handle to secure the at least one joining member, the stem and the one of the handle together.

3. The bicycle handlebar assembly according to claim 2, wherein the joining structures of the joining member comprise at least two screw holes.

4. The bicycle handlebar assembly according to claim 1, further comprising a connecting seat for an extension handle, wherein the connecting seat comprises a linking structure and is mounted to the stem or disposed above or under the handles, and the fastening members extend through the linking structure of the extension handle, the mounting hole of the stem and the connecting hole of connecting structures of one of the handles to secure the extension handle, the stem and the one of the handle together.

5. The bicycle handlebar assembly according to claim 4, wherein the connecting seat further comprises a clamping portion for the extension handle and a mounting portion for a pad, and the mounting portion comprises a plurality of positioning holes configured to position the pad.

6. The bicycle handlebar assembly according to claim 4, wherein the linking structure of the extension handle comprises at least two screw holes.

7. The bicycle handlebar assembly according to claim 1, wherein the connecting structures of each of the handles comprise at least two screw holes.
